(19) United States
(12) Patent Application Publication
(10) Pub. No.: US 2024/0143474 A1
(43) Pub. Date: May 2, 2024

(54) SYSTEM AND METHOD FOR DYNAMIC SENSORS SUPPORT IN IPMI STACK

(71) Applicant: American Megatrends International, LLC, Duluth, GA (US)

(72) Inventors: Jason Messer, Duluth, GA (US); Balaji Nagalingam Rajendiran, Duluth, GA (US); Senathipathy Thangavel, Karur (IN); Aashray Boddu, Chennai (IN); Madhavan Selvaraj, Chennai (IN)

(21) Appl. No.: 17/974,874

(22) Filed: Oct. 27, 2022

(51) Int. Cl. G06F 11/30; G06F 9/4401; G06F 13/40

(52) U.S. Cl. CPC G06F 11/3089; G06F 9/4401; G06F 13/4081

(57) ABSTRACT

Systems and methods for dynamic sensors support in an Intelligent Platform Management Interface (IPMI) stack. A dynamic sensor monitor task is provided. In operation, the task initiates a plurality of dynamic sensor tables. In a sensor monitor cycle, the task monitors a plurality of sensors to be monitored, in order to get sensor reading information from the sensors. When the task determines that an entity presence sensor event is detected, the task updates a sensor data repository (SDR) and sensor information of at least one dynamic sensor according to the entity presence sensor event, and updates the dynamic sensor tables. Once the sensor monitor cycle is completed and the task determines that the dynamic sensor tables are updated, the task updates the SDR and the sensor information of the at least one dynamic sensor to the IPMI stack based on the updated dynamic sensor tables.

### FIELD

The present disclosure relates generally to Intelligent Platform Management Interface (IPMI) and sensor technology, and more particularly to systems and methods for dynamic sensors support in an IPMI stack.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Currently, in a baseboard management controller (BMC), the BMC firmware is limited to not being able to expand the list of monitored sensors on runtime. For example, when hot-pluggable cards or devices are inserted to the server, the BMC firmware may not be able to expand the list of the monitored sensors related to the hot-pluggable cards or devices. Examples of the hot-pluggable cards or devices may include, without being limited thereto, field-replaceable unit (FRU) input/output (I/O) cards, PCE, SSD, midplane controllers, etc., and the hot-pluggable cards or devices may have many sensors thereon, such as temperature sensors, voltage sensors, current sensors, or other types of sensors. This issue becomes a major drawback when the BMC not able to provide the sensor related information of the hot-pluggable cards or devices to the user which is internally existing in the server.

With the current Intelligent Platform Management Interface (IPMI) stack, it is impossible for the BMC to monitor the sensors in the hot-pluggable cards or devices that are inserted into or removed from the server. In order to allow the BMC to monitor the sensors in the hot-pluggable cards or devices, an existing solution is to add the sensor monitoring code and the sensor data repository (SDR) for each sensor in the hot-pluggable cards or devices into the IPMI stack and create a corresponding new BMC image. However, the BMC must be flashed with the new BMC image and rebooted to include the sensors as a part of the IPMI stack.

Therefore, an unaddressed need exists in the art to address the aforementioned deficiencies and inadequacies.

### SUMMARY

Certain aspects of the disclosure direct to a system, which includes a baseboard management controller (BMC), comprising a processor and a storage device. The storage device stores an Intelligent Platform Management Interface (IPMI) stack and computer executable code. The computer executable code is configured to, when executed at the processor: initiate a plurality of dynamic sensor tables; in a sensor monitor cycle: monitor a plurality of sensors to be monitored, in order to get sensor reading information from each of the sensors; determine whether an entity presence sensor event is detected, wherein the entity presence sensor event is related to at least one dynamic sensor to be added to or removed from the sensors to be monitored; and in response to detecting the entity presence sensor event, update a sensor data repository (SDR) and sensor information of the at least one dynamic sensor according to the entity presence sensor event, and update the dynamic sensor tables; in response to determining that the sensor monitor cycle is completed, determine whether the dynamic sensor tables are updated; and in response to determining the dynamic sensor tables are updated, update the SDR and the sensor information of the at least one dynamic sensor to the IPMI stack based on the updated dynamic sensor tables.

In certain embodiments, the at least one dynamic sensor is on a hot-pluggable device to be inserted into or removed from a host computing device communicatively connected to the BMC.

In certain embodiments, the computer executable code is further configured to, when executed at the processor: detect an insertion event related to the hot-pluggable device to be inserted into the host computing device; and in response to detecting the insertion event, determine that the entity presence sensor event related to the at least one dynamic sensor to be added is detected.

In certain embodiments, the computer executable code is further configured to, when executed at the processor: detect a removal event related to the hot-pluggable device to be removed from the host computing device; and in response to detecting the removal event, determine that the entity presence sensor event related to the at least one dynamic sensor to be removed is detected.

In certain embodiments, the dynamic sensor tables include: a dynamic sensor information table, configured to store the sensor information of the sensors to be monitored; a dynamic SDR table, configured to store the SDR of at least one first dynamic sensor to be added to the sensors to be monitored; and a dynamic sensor remove table, configured to store a sensor number of at least one second dynamic sensor to be removed from the sensors to be monitored.

In certain embodiments, the entity presence sensor event is a first entity presence sensor event related to the at least one first dynamic sensor to be added to the sensors to be monitored, and the computer executable code is configured to, when executed at the processor: detect the first entity presence sensor event; create the SDR and the sensor information of the at least one first dynamic sensor according to the first entity presence sensor event; update the dynamic sensor information table to add the sensor information of the at least one first dynamic sensor thereto; and update the dynamic SDR table to add the SDR of the at least one first dynamic sensor thereto.

In certain embodiments, the entity presence sensor event is a second entity presence sensor event related to the at least one second dynamic sensor to be removed from the sensors to be monitored, and the computer executable code is configured to, when executed at the processor: detect the second entity presence sensor event; remove the SDR and the sensor information of the at least one second dynamic sensor according to the second entity presence sensor event; update the dynamic sensor information table to remove the sensor information of the at least one second dynamic sensor therefrom; and update the dynamic sensor remove table to add the sensor number of the at least one second dynamic sensor thereto.

In certain embodiments, the computer executable code is further configured to, when executed at the processor: in response to updating the SDR and the sensor information of the at least one dynamic sensor, post an event message in a system event log (SEL).

Certain aspects of the disclosure direct to a method for dynamic sensors support in an Intelligent Platform Management Interface (IPMI) stack of a baseboard management controller (BMC). In certain embodiments, the method includes: initiating, in a memory of the BMC, a plurality of dynamic sensor tables; in a sensor monitor cycle: monitoring a plurality of sensors to be monitored, in order to get sensor reading information from each of the sensors; determining whether an entity presence sensor event is detected, wherein the entity presence sensor event is related to at least one dynamic sensor to be added to or removed from the sensors to be monitored; and in response to detecting the entity presence sensor event, updating a sensor data repository (SDR) and sensor information of the at least one dynamic sensor according to the entity presence sensor event, and updating the dynamic sensor tables; in response to determining that the sensor monitor cycle is completed, determining whether the dynamic sensor tables are updated; and in response to determining the dynamic sensor tables are updated, updating the SDR and the sensor information of the at least one dynamic sensor to the IPMI stack based on the updated dynamic sensor tables.

In certain embodiments, the at least one dynamic sensor is on a hot-pluggable device to be inserted into or removed from a host computing device communicatively connected to the BMC.

In certain embodiments, the method further includes: detecting an insertion event related to the hot-pluggable device to be inserted into the host computing device; and in response to detecting the insertion event, determining that the entity presence sensor event related to the at least one dynamic sensor to be added is detected.

In certain embodiments, the method further includes: detecting a removal event related to the hot-pluggable device to be removed from the host computing device; and in response to detecting the removal event, determining that the entity presence sensor event related to the at least one dynamic sensor to be removed is detected.

In certain embodiments, the dynamic sensor tables include: a dynamic sensor information table, configured to store the sensor information of the sensors to be monitored; a dynamic SDR table, configured to store the SDR of at least one first dynamic sensor to be added to the sensors to be monitored; and a dynamic sensor remove table, configured to store a sensor number of at least one second dynamic sensor to be removed from the sensors to be monitored.

In certain embodiments, the entity presence sensor event is a first entity presence sensor event related to the at least one first dynamic sensor to be added to the sensors to be monitored, and the method further includes: detecting the first entity presence sensor event; creating the SDR and the sensor information of the at least one first dynamic sensor according to the first entity presence sensor event; updating the dynamic sensor information table to add the sensor information of the at least one first dynamic sensor thereto; and updating the dynamic SDR table to add the SDR of the at least one first dynamic sensor thereto.

In certain embodiments, the entity presence sensor event is a second entity presence sensor event related to the at least one second dynamic sensor to be removed from the sensors to be monitored, and the method further includes: detecting the second entity presence sensor event; removing the SDR and the sensor information of the at least one second dynamic sensor according to the second entity presence sensor event; updating the dynamic sensor information table to remove the sensor information of the at least one second dynamic sensor therefrom; and updating the dynamic sensor remove table to add the sensor number of the at least one second dynamic sensor thereto.

In certain embodiments, the method further includes: in response to updating the SDR and the sensor information of the at least one dynamic sensor, posting an event message in a system event log (SEL).

Certain aspects of the invention relate to a non-transitory computer readable medium storing computer executable code, wherein the computer executable code, when executed at a processor of a baseboard management controller (BMC), is configured to: initiate, in a memory of the BMC, a plurality of dynamic sensor tables; in a sensor monitor cycle: monitor a plurality of sensors to be monitored, in order to get sensor reading information from each of the sensors; determine whether an entity presence sensor event is detected, wherein the entity presence sensor event is related to at least one dynamic sensor to be added to or removed from the sensors to be monitored; and in response to detecting the entity presence sensor event, update a sensor data repository (SDR) and sensor information of the at least one dynamic sensor according to the entity presence sensor event, and update the dynamic sensor tables; in response to determining that the sensor monitor cycle is completed, determine whether the dynamic sensor tables are updated; and in response to determining the dynamic sensor tables are updated, update the SDR and the sensor information of the at least one dynamic sensor to the IPMI stack based on the updated dynamic sensor tables.

In certain embodiments, the dynamic sensor tables include: a dynamic sensor information table, configured to store the sensor information of the sensors to be monitored; a dynamic SDR table, configured to store the SDR of at least one first dynamic sensor to be added to the sensors to be monitored; and a dynamic sensor remove table, configured to store a sensor number of at least one second dynamic sensor to be removed from the sensors to be monitored.

In certain embodiments, the entity presence sensor event is a first entity presence sensor event related to the at least one first dynamic sensor to be added to the sensors to be monitored, and the computer executable code is configured to, when executed at the processor: detect the first entity presence sensor event; create the SDR and the sensor information of the at least one first dynamic sensor according to the first entity presence sensor event; update the dynamic sensor information table to add the sensor information of the at least one first dynamic sensor thereto; and update the dynamic SDR table to add the SDR of the at least one first dynamic sensor thereto.

In certain embodiments, the entity presence sensor event is a second entity presence sensor event related to the at least one second dynamic sensor to be removed from the sensors to be monitored, and the computer executable code is configured to, when executed at the processor: detect the second entity presence sensor event; remove the SDR and the sensor information of the at least one second dynamic sensor according to the second entity presence sensor event; update the dynamic sensor information table to remove the sensor information of the at least one second dynamic sensor therefrom; and update the dynamic sensor remove table to add the sensor number of the at least one second dynamic sensor thereto.

These and other aspects of the present disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, wherein:

FIG. 1 schematically depicts an exemplary system according to certain embodiments of the present disclosure.

FIG. 2 schematically depicts a plurality of dynamic sensor tables created by the dynamic sensor module of FIG. 1 according to certain embodiments of the present disclosure.

FIG. 3A schematically depicts insertion of a hot-pluggable device/card with dynamic sensors into a host computing device according to certain embodiments of the present disclosure.

FIG. 3B schematically depicts removal of a hot-pluggable device/card with dynamic sensors from a host computing device according to certain embodiments of the present disclosure.

FIG. 4 depicts a flowchart of a method for dynamic sensors support in an IPMI stack of a BMC according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The terms “chip” or “computer chip”, as used herein, generally refer to a hardware electronic component, and may refer to or include a small electronic circuit unit, also known as an integrated circuit (IC), or a combination of electronic circuits or ICs.

Certain embodiments of the present disclosure relate to computer technology. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

As discussed above, with the current IPMI stack, there is no way for the BMC to monitor the sensors in hot-pluggable cards or devices without flashing the BMC with the new BMC image and rebooting the BMC, such that the sensors in the hot-pluggable cards or devices are included as a part of the IPMI stack. Hence, the BMC needs the capability to add the SDR and other corresponding sensor information to the IPMI stack on the runtime, without the need to restart the IPMI stack and the BMC or update the firmware thereof.

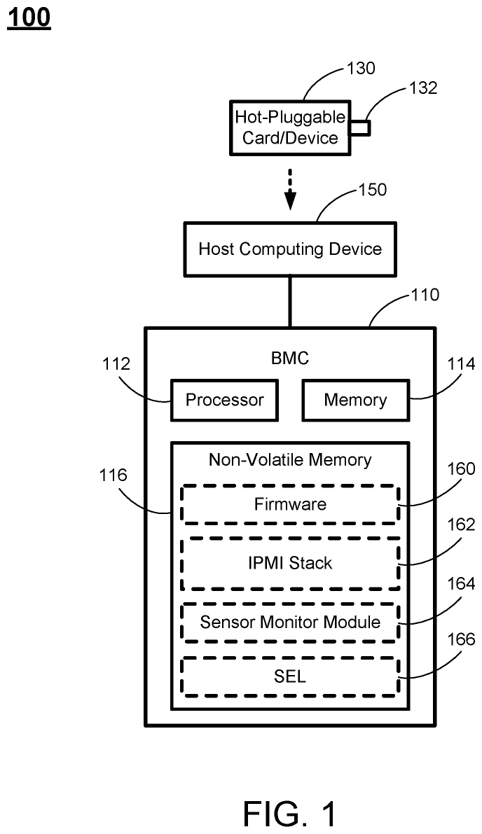

Certain aspects of the present disclosure direct to systems and methods for dynamic sensors support in an Intelligent Platform Management Interface (IPMI) stack in a BMC. FIG. 1 schematically depicts an exemplary system according to certain embodiments of the present disclosure. As shown in FIG. 1, the system 100 includes a BMC 110 being communicatively connected to a host computing device 150, and a hot-pluggable card/device 130 that may be inserted into or removed from the host computing device 150. The hot-pluggable card/device 130 may include at least one dynamic sensor 132 thereon. Specifically, the term “dynamic sensor” is in comparison to the “static sensor” (i.e., the sensor existing on the host computing device 150 when the BMC 110 starts monitoring the host computing device 150), as the hot-pluggable card/device 130 may be inserted into the host computing device 150 or removed from the host computing device 150 at any time, resulting in the need to add or remove the dynamic sensor 132 (or multiple dynamic sensors 132) on the hot-pluggable card/device 130 at runtime.

The BMC 110 is a specialized management controller used to monitor the operation of the host computing device 150. In certain embodiment, the BMC 110 and the host computing device 150 may be in communication through an interface, which may be a system interface, a universal serial bus (USB) interface or a network, or any other types of interfaces to communicatively connect the BMC 110 to the host computing device 150. In certain embodiments, different types of sensors can be built into the host computing device 150, and the BMC 110 reads these sensors to obtain parameters such as temperature, cooling fan speeds, power status, OS status, etc.

In certain embodiments, the BMC 110 may include necessary hardware and software components to perform certain predetermined tasks. For example, as shown in FIG. 1, the BMC 110 includes a processor 112, a memory 114, and a non-volatile memory 116. Further, the BMC 110 may include other hardware components and software components (not shown) to perform its corresponding tasks. Examples of these hardware and software components may include, but not limited to, other required memory, interfaces, buses, network interfaces, I/O modules and peripheral devices.

The processor 112 is configured to control operation of the BMC 110. In certain embodiments, the processor 112 may be a central processing unit (CPU). The processor 112 can execute or access any computer executable code or instructions, such as the firmware 160, the IPMI stack 162, the sensor monitor module 164 and the system event log (SEL) 166 of the BMC 110 or other applications and instructions of the BMC 110. In certain embodiments, the BMC 110 may run on more than one processor, such as two processors, four processors, eight processors, or any suitable number of processors.

The memory 114 can be a volatile memory, such as the random-access memory (RAM), for storing the data and information during the operation of the BMC 110. In certain embodiments, the memory 114 may be a volatile memory array. In certain embodiments, the BMC 110 may include multiple volatile memory modules 114.

The non-volatile memory 116 is a data storage media for storing the applications of the BMC 110. Examples of the non-volatile memory 116 may include flash memory, memory cards, USB drives, hard drives, floppy disks, optical drives, or any other types of non-volatile data storage devices. In certain embodiments, the BMC 110 may have multiple non-volatile memory modules 116, which may be identical storage devices or different types of storage devices, and the applications may be stored in one or more of the non-volatile memory 116 of the BMC 110.

As shown in FIG. 1, the non-volatile memory 116 of the BMC 110 stores the firmware 160, the IPMI stack 162, the sensor monitor module 164 and the SEL 166. In certain embodiments, the non-volatile memory 116 may include other applications, modules or data necessary for the operation of the BMC 110. It should be noted that all of the modules are each implemented by computer executable codes or instructions, which collectively forms a software image. In certain embodiments, each of the modules may further include sub-modules. Alternatively, some of the modules may be combined as one stack.

The firmware 160 includes the computer executable code that may be executed at the processor 112 to enable the operations of the BMC 110. In certain embodiments, the firmware 160 may include one or more modules or software components that may be executed independently. In certain embodiments, the IPMI stack 162 and the SEL 166 may be a part of the firmware 160. In certain embodiments, each of the IPMI stack 162, the sensor monitor module 164 and the SEL 166 may respectively be a separate module independent from the firmware 160.

The IPMI stack 162 is a software module that provides the IPMI features for the BMC 110. In certain embodiments, the IPMI stack 162 supports basic sensor monitoring features in order to continuously monitor the sensor values and react accordingly, thus monitoring and managing the whole system 100. Examples of the sensor monitoring features include, without being limited thereto, reading data from the sensors or writing data to the sensors. In addition, the IPMI stack 162 provides certain functions that may be utilized in the dynamic sensor monitoring process performed by the sensor monitor module 164.

The sensor monitor module 164 is a software module used to perform the dynamic sensor monitoring process, facilitating the capability to add the SDR and other corresponding sensor information of dynamic sensors to the IPMI stack on the runtime, without the need to restart the IPMI stack and the BMC or update the firmware thereof. Specifically, when the sensor monitor module 164 is executed, a dynamic sensor monitor task (hereinafter the “task”) is created to perform the dynamic sensor monitoring process. In certain embodiments, the sensor monitor module 164 is generally called by the IPMI stack 162 to create the task during the system initialization of the BMC 110. The task is responsible for all the actions related to the sensors, such as reading the sensors, updating sensor readings, checking for new event (i.e., compare the sensor reading with threshold or previous state for any new event) based on the sensor readings, and checking whether there is a need to log the event using event mask from the SDR and post the events to a message handler task and PEF task to log SEL events.

The SEL 166 is a log created by the IPMI stack 162 that may be used to record the system events in a specific format defined by the IPMI specification. In certain embodiments, whenever there is an update to the SDR and the sensor information of the dynamic sensors, the task may post an event message in the SEL 166.

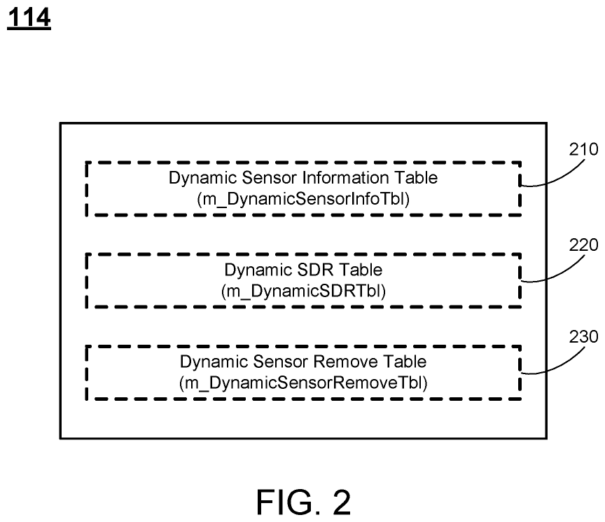

Specifically, in operation, when the sensor monitor module 164 is executed to create the task, the task may firstly initiate a plurality of dynamic sensor tables. In certain embodiments, the task may call the InitDynamicSensor( ) function provided by the IPMI stack 162 to allocate memory the dynamic sensor tables of which are used by the task to add or remove the SDR of the dynamic sensors. For example, FIG. 2 schematically depicts a plurality of dynamic sensor tables created by the dynamic sensor module of FIG. 1 according to certain embodiments of the present disclosure. As shown in FIG. 2, the dynamic sensor tables include a dynamic sensor information table (m_DynamicSensorInfoTbl) 210, a dynamic SDR table (m_DynamicSDRTbl) 220, and a dynamic sensor remove table (m_DynamicSensorRemoveTbl) 230. The dynamic sensor information table 210 is a table to store the sensor information of the dynamic sensors to be monitored. The dynamic SDR table 220 is a table to store the SDR of the dynamic sensor to be added (or the SDR of each dynamic sensor in the case where multiple dynamic sensors are to be added) to the sensors to be monitored. The dynamic sensor remove table 230 is a table to store a sensor number of the dynamic sensor to be removed (or the sensor number of each dynamic sensor in the case where multiple dynamic sensors are to be removed) from the sensors to be monitored.

Once the dynamic sensor tables are created, the task then starts processing the dynamic sensor changes by starting a sensor monitor cycle. Specifically, the task may call the ProcessDynamicSensorChanges( ) function provided by the IPMI stack 162 before each sensor monitor cycle starts to monitor the dynamic sensor tables to add or remove sensor from the IPMI Stack 162. It should be noted that the sensor monitor module 164 is generally called by the IPMI stack 162 to create the task during the system initialization of the BMC 110. In other words, the first sensor monitor cycle of the task may occur during the BMC bootup or initialization. At this time, the task may check to see if any dynamic sensor (or multiple dynamic sensors) need to be add or merged to or removed from the IPMI stack 162. If merge is needed, the task performs the merging/adding process to merge/add the dynamic sensor information data structures and the SDRs of the dynamic sensor(s) to the IPMI stack 162. Specifically, the task may collects the SDR record (from the dynamic SDR table 220) and the sensor information (from the dynamic sensor information table 210) of each dynamic sensor to be added, and then call to the AddDynamicSensor( ) function provided by the IPMI stack 162, which adds the collected SDR record the sensor information to the IPMI stack 162. On the other hand, if removal is needed, the task performs the removal process to clear/delete the dynamic sensor information data structures and the SDRs of the dynamic sensor(s) to be added from the IPMI stack 162. Specifically, the task may collect the sensor number of each dynamic sensor to be removed from the dynamic sensor remove table 230, and then call to the RemoveDynamicSensor( ) function provided by the IPMI stack 162 to delete the SDR record and the sensor information of the dynamic sensor(s) to be removed from the IPMI stack 162.

Once a sensor monitor cycle starts, in the sensor monitor cycle, the task monitors a plurality of sensors to be monitored (including the static sensors and/or the dynamic sensors that have been added to the host computing device 150), in order to get sensor reading information from the sensors. In certain embodiments, the task reads data from either the hardware abstraction layer (HAL) or the FRU library to get the sensor reading. For example, the task may call the GetDynamicSensorReading( ) function to read the access details of each sensor from the dynamic sensor information table 210, and calls the appropriate library function for each sensor and get the sensor reading for that sensor. The HAL is the module which will communicate to the real hardware to get real time information of the sensor, and the HAL internally uses some driver to get real values. The HAL has general function to read, write data from or to I2C devices like sensors.

Meanwhile, the task may keep monitoring whether an entity presence sensor event is detected. In certain embodiments, the entity presence sensor event may be related to at least one dynamic sensor to be added to the sensors to be monitored, or may be related to at least one dynamic sensor to be removed from the sensors to be monitored. When the task determines that an entity presence sensor event is detected, the task updates a SDR and sensor information of a dynamic sensor (or multiple dynamic sensors) according to the entity presence sensor event, and updates the dynamic sensor tables. In other words, the dynamic sensor tables may be updated in response to detecting a corresponding entity presence sensor event. The task may also post an event message in the SEL 166.

Once the sensor monitor cycle is completed, the task may then determines whether the dynamic sensor tables are updated. In the case where the task determines that the dynamic sensor tables are updated, the task updates the SDR and the sensor information of the dynamic sensor (or multiple dynamic sensors) to the IPMI stack 162 based on the updated dynamic sensor tables, and posts a corresponding event message in the SEL 166. The updating process is similar to the merging/removal processes as described above. If merge is needed, the task performs the merging/adding process to merge/add the dynamic sensor information data structures and the SDRs of the dynamic sensor(s) to the IPMI stack 162. Specifically, the task may collects the SDR record (from the dynamic SDR table 220) and the sensor information (from the dynamic sensor information table 210) of each dynamic sensor to be added, and then call to the AddDynamicSensor( ) function provided by the IPMI stack 162, which adds the collected SDR record the sensor information to the IPMI stack 162. On the other hand, if removal is needed, the task performs the removal process to clear/delete the dynamic sensor information data structures and the SDRs of the dynamic sensor(s) to be added from the IPMI stack 162. Specifically, the task may collect the sensor number of each dynamic sensor to be removed from the dynamic sensor remove table 230, and then call to the RemoveDynamicSensor( ) function provided by the IPMI stack 162 to delete the SDR record and the sensor information of the dynamic sensor(s) to be removed from the IPMI stack 162. Finally, the task moves on to the next sensor monitor cycle to keep monitoring other possible entity presence sensor events.

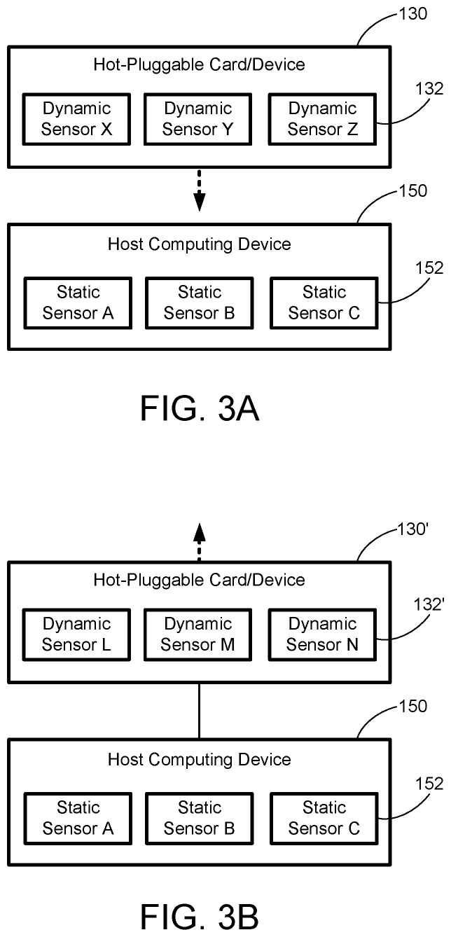

In certain embodiments, the dynamic sensor may be on a hot-pluggable device to be inserted into or removed from a host computing device communicatively connected to the BMC. For example, FIG. 3A schematically depicts insertion of a hot-pluggable device/card with dynamic sensors into a host computing device according to certain embodiments of the present disclosure, and FIG. 3B schematically depicts removal of a hot-pluggable device/card with dynamic sensors from a host computing device according to certain embodiments of the present disclosure. As shown in FIG. 3A, the host computing device 150 has three static sensors 152, including the static sensors A, B and

C. The hot-pluggable card/device 130 has three dynamic sensors 132, including the dynamic sensors X, Y and Z. Since the hot-pluggable card/device 130 is to be inserted into the host computing device 150, the dynamic sensors X, Y and Z on the hot-pluggable card/device 130 will be available. In certain embodiments, the task may detect an insertion event related to the hot-pluggable card/device 130 to be inserted into the host computing device 150, as shown in FIG. 3A. Specifically, the IsIOEntityPresenceEvent( ) function would detect the insertion event, and the task also logs the SEL event for the presence (i.e., the insertion) of the hot-pluggable card/device 130. In this case, in response to detecting the insertion event, the task may determine that the entity presence sensor event related to the dynamic sensors X, Y and Z to be added is detected. Thus, the entity presence sensor event is a first entity presence sensor event related to the dynamic sensors X, Y, Z (hereinafter the “first” dynamic sensors) to be added to the sensors to be monitored. Once the first entity presence sensor event is detected, the task may create the SDR and the sensor information of each of the first dynamic sensors X, Y and Z according to the first entity presence sensor event, update the dynamic sensor information table to add the sensor information of the first dynamic sensors X, Y and Z thereto, and update the dynamic SDR table to add the SDR of the first dynamic sensors X, Y and Z thereto. Specifically, the task may utilize the API HandlelOEntityPresenceEvent( ) to call the API BuildDynamicSensors( ) which uses the FRU Manager Library to determine how many sensors the FRU reports, and for each sensor, builds an SDR record and Sensor Information data structure stored in a configurable SDR configuration file (which may be edited by a user at the runtime to add/update the SDR and the sensor information data) or a EEPROM (where the user can use the program provided by the EEPROM to store the SDR and the sensor information data), and add them to the dynamic SDR table 220 and the dynamic sensor information table 210. In certain embodiments, the task may utilize the API HandlelOEntityPresenceEvent( ) to update a variable m_DynamicSensorMergeCnt, which holds the number of sensors to be added for the hot-pluggable card/device 130 (e.g., 3 dynamic sensors X, Y and Z). In this way, the task treats the dynamic sensors X, Y and Z similar to the static sensors A, B and C of the IPMI stack like monitoring and logging the events. In certain embodiments, the event message is deferred from being posted in the SEL 166 until the SDR and Sensor Information data structure of the dynamic sensors are added to the IPMI stack by the ProcessDynamicSensorChanges( ) function in the next sensor monitor cycle.

As shown in FIG. 3B, the host computing device 150 has three static sensors 152, including the static sensors A, B and C. The hot-pluggable card/device 130′ to be removed from the host computing device 150 has three dynamic sensors 132′, including the dynamic sensors L, M and N. Since the hot-pluggable card/device 130′ is to be removed from the host computing device 150, the dynamic sensors L, M and N on the hot-pluggable card/device 130′ will be unavailable after the removal. In certain embodiments, the task may detect a removal event related to the hot-pluggable card/device 130′ to be removed from the host computing device 150, as shown in FIG. 3B. Specifically, the IsIOEntityPresenceEvent( ) function would detect the removal event, and the task also logs the SEL event for the absence (i.e., the removal) of the hot-pluggable card/device 130. In this case, in response to detecting the removal event, the task may determine that the entity presence sensor event related to the dynamic sensors L, M and N to be removed is detected. Thus, the entity presence sensor event is a second entity presence sensor event related to the dynamic sensors L, M and N (hereinafter the “second” dynamic sensors) to be removed from the sensors to be monitored. Once the second entity presence sensor event is detected, the task may remove the SDR and the sensor information of the second dynamic sensors L, M and N according to the second entity presence sensor event, update the dynamic sensor information table 210 to remove the sensor information of the second dynamic sensors L, M and N therefrom, and update the dynamic sensor remove table 230 to add the sensor number of each of the second dynamic sensors L, M and N thereto. Specifically, the task may utilize the API HandleIOEntityPresenceEvent( ) to update the variable m_DynamicSensorRemoveCnt, which holds the number of sensors to be removed, and to update the dynamic sensor remove table 230. In this way, the task removes the dynamic sensors L, M and N from the sensors to be monitored by marking the sensor numbers of the dynamic sensors L, M and N in the dynamic sensor remove table 230, leaving the static sensors A, B and C of the IPMI stack as the sensors to be monitored. The sensors in the dynamic sensor remove table 230 will be removed later from the IPMI stack 162. Also, the event message is posted in the SEL 166 immediately, since there is no need to defer entity removal events.

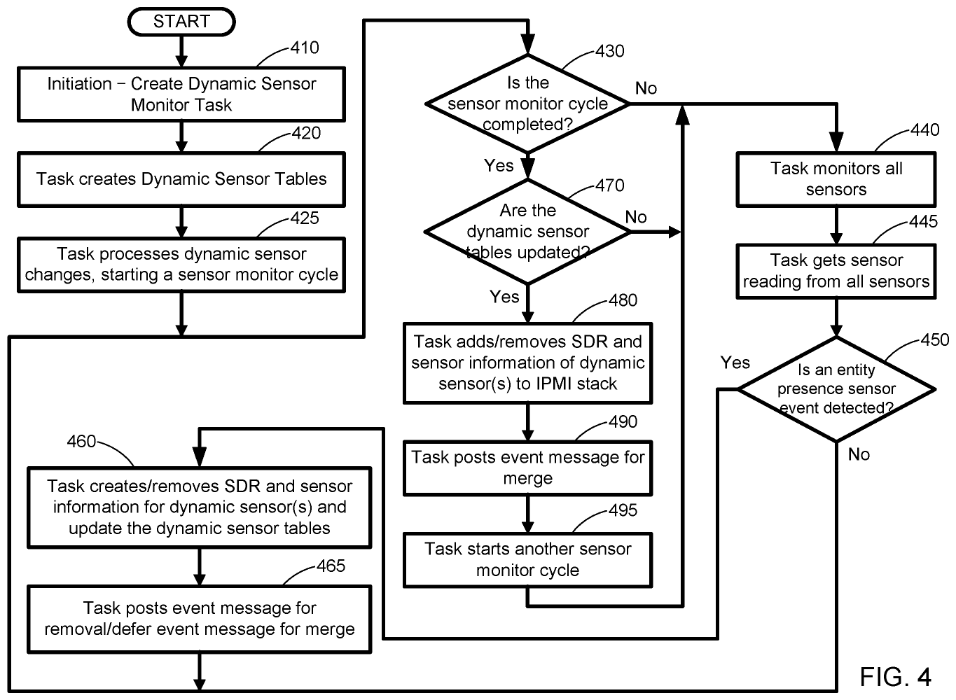

FIG. 4 depicts a flowchart of a method for dynamic sensors support in an IPMI stack of a BMC according to certain embodiments of the present disclosure. In certain embodiments, the method as shown in FIG. 4 may be implemented by a system as shown in FIG. 1 for dynamic sensors support in the IPMI stack 162. In certain embodiments, the method may be implemented by the task created by the sensor monitor module 164 as shown in FIG. 1. It should be particularly noted that, unless otherwise stated in the present disclosure, the steps of the method may be arranged in a different sequential order, and are thus not limited to the sequential order as shown in FIG. 4.

As shown in FIG. 4, at procedure 410, a initiation process is performed to create the dynamic sensor monitor task. At procedure 420, the task creates the dynamic sensor tables, including the dynamic sensor information table 210, the dynamic SDR table 220 and the dynamic sensor remove table 230. At procedure 425, the task processes the dynamic sensor changes to start a sensor monitor cycle.

At procedure 430, the task determines whether the sensor monitor cycle is completed. Since the sensor monitor cycle just starts, the task moves to procedure 440 to monitor all sensors, including the static sensors and all dynamic sensors that have been added to the IPMI stack. At procedure 445, the task gets the sensor reading from all sensors.

At procedure 450, the task determines whether an entity presence sensor event is detected. In the case where no entity presence sensor event is detected, the task moves back to the procedure 430 to determine whether the sensor monitor cycle is completed. In the case where an entity presence sensor event is detected, the task performs the corresponding adding/removal procedures based on the entity presence sensor event to create/remove the SDR and the sensor information for the dynamic sensor(s), and update the dynamic sensor tables. Details of the updating process have been discussed above. When the entity presence sensor event is related to a removal process, at procedure 465, the event message is posted in the SEL 166 immediately, since there is no need to defer entity removal events. When the entity presence sensor event is related to a adding/merging process, at the procedure 465, the event message is deferred from being posted in the SEL 166 until the SDR and Sensor Information data structure of the dynamic sensors are added to the IPMI stack by the ProcessDynamicSensorChanges( ) function in the next sensor monitor cycle.

Referring back to the procedure 430, once the sensor monitor cycle is completed, the task determines whether the dynamic sensors tables are updated. If there is no update to the dynamic sensors tables, the task may start another sensor monitor cycle immediately. In the case where the dynamic sensors tables are updated, at procedure 470, the task adds/removes the SDR and the sensor information of the dynamic sensor(s) to the IPMI stack. Details of the adding/removing process have been discussed above. Then, at procedure 490, the task posts the deferred event message for the merging/adding process. At procedure 495, the task may start another sensor monitor cycle, and moves back to the procedure 440.

The systems and methods according to certain embodiments of the invention provide an easier way to detect the event generated when a hot-pluggable device/card is inserted or removed and to add or remove sensor information and SDR records to IPMI at runtime.

In a further aspect, the present disclosure is related to a non-transitory computer readable medium storing computer executable code. The code, when executed at a processer of a controller, may perform the method as described above. In certain embodiments, the non-transitory computer readable medium may include, but not limited to, any physical storage media as the non-volatile memory 116 of the BMC 110 as shown in FIG. 1.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A system, comprising:
a baseboard management controller (BMC), comprising a processor and a storage device, wherein the storage device stores an Intelligent Platform Management Interface (IPMI) stack and computer executable code, wherein the computer executable code is configured to, when executed at the processor:
initiate a plurality of dynamic sensor tables;
in a sensor monitor cycle:
monitor a plurality of sensors to be monitored, in order to get sensor reading information from each of the sensors;
determine whether an entity presence sensor event is detected, wherein the entity presence sensor event is related to at least one dynamic sensor to be added to or removed from the sensors to be monitored; and
in response to detecting the entity presence sensor event, update a sensor data repository (SDR) and sensor information of the at least one dynamic sensor according to the entity presence sensor event, and update the dynamic sensor tables;
in response to determining that the sensor monitor cycle is completed, determine whether the dynamic sensor tables are updated; and
in response to determining the dynamic sensor tables are updated, update the SDR and the sensor information of the at least one dynamic sensor to the IPMI stack based on the updated dynamic sensor tables.

2. The system of claim 1, wherein the at least one dynamic sensor is on a hot-pluggable device to be inserted into or removed from a host computing device communicatively connected to the BMC.

3. The system of claim 2, wherein the computer executable code is further configured to, when executed at the processor:
detect an insertion event related to the hot-pluggable device to be inserted into the host computing device; and
in response to detecting the insertion event, determine that the entity presence sensor event related to the at least one dynamic sensor to be added is detected.

4. The system of claim 2, wherein the computer executable code is further configured to, when executed at the processor:
detect a removal event related to the hot-pluggable device to be removed from the host computing device; and
in response to detecting the removal event, determine that the entity presence sensor event related to the at least one dynamic sensor to be removed is detected.

5. The system of claim 1, wherein the dynamic sensor tables comprise:
a dynamic sensor information table, configured to store the sensor information of the sensors to be monitored;
a dynamic SDR table, configured to store the SDR of at least one first dynamic sensor to be added to the sensors to be monitored; and
a dynamic sensor remove table, configured to store a sensor number of at least one second dynamic sensor to be removed from the sensors to be monitored.

6. The system of claim 5, wherein the entity presence sensor event is a first entity presence sensor event related to the at least one first dynamic sensor to be added to the sensors to be monitored, and the computer executable code is configured to, when executed at the processor:
detect the first entity presence sensor event;
create the SDR and the sensor information of the at least one first dynamic sensor according to the first entity presence sensor event;
update the dynamic sensor information table to add the sensor information of the at least one first dynamic sensor thereto; and
update the dynamic SDR table to add the SDR of the at least one first dynamic sensor thereto.

7. The system of claim 5, wherein the entity presence sensor event is a second entity presence sensor event related to the at least one second dynamic sensor to be removed from the sensors to be monitored, and the computer executable code is configured to, when executed at the processor:
detect the second entity presence sensor event;
remove the SDR and the sensor information of the at least one second dynamic sensor according to the second entity presence sensor event;
update the dynamic sensor information table to remove the sensor information of the at least one second dynamic sensor therefrom; and
update the dynamic sensor remove table to add the sensor number of the at least one second dynamic sensor thereto.

8. The system of claim 1, wherein the computer executable code is further configured to, when executed at the processor:
in response to updating the SDR and the sensor information of the at least one dynamic sensor, post an event message in a system event log (SEL).

9. A method for dynamic sensors support in an Intelligent Platform Management Interface (IPMI) stack of a baseboard management controller (BMC), comprising:
initiating, in a memory of the BMC, a plurality of dynamic sensor tables;
in a sensor monitor cycle:
monitoring a plurality of sensors to be monitored, in order to get sensor reading information from each of the sensors;
determining whether an entity presence sensor event is detected, wherein the entity presence sensor event is related to at least one dynamic sensor to be added to or removed from the sensors to be monitored; and
in response to detecting the entity presence sensor event, updating a sensor data repository (SDR) and sensor information of the at least one dynamic sensor according to the entity presence sensor event, and updating the dynamic sensor tables;
in response to determining that the sensor monitor cycle is completed, determining whether the dynamic sensor tables are updated; and
in response to determining the dynamic sensor tables are updated, updating the SDR and the sensor information of the at least one dynamic sensor to the IPMI stack based on the updated dynamic sensor tables.

10. The method of claim 9, wherein the at least one dynamic sensor is on a hot-pluggable device to be inserted into or removed from a host computing device communicatively connected to the BMC.

11. The method of claim 10, further comprising:
detecting an insertion event related to the hot-pluggable device to be inserted into the host computing device; and
in response to detecting the insertion event, determining that the entity presence sensor event related to the at least one dynamic sensor to be added is detected.

12. The method of claim 10, further comprising:
detecting a removal event related to the hot-pluggable device to be removed from the host computing device; and
in response to detecting the removal event, determining that the entity presence sensor event related to the at least one dynamic sensor to be removed is detected.

13. The method of claim 9, wherein the dynamic sensor tables comprise:
a dynamic sensor information table, configured to store the sensor information of the sensors to be monitored;
a dynamic SDR table, configured to store the SDR of at least one first dynamic sensor to be added to the sensors to be monitored; and
a dynamic sensor remove table, configured to store a sensor number of at least one second dynamic sensor to be removed from the sensors to be monitored.

14. The method of claim 13, wherein the entity presence sensor event is a first entity presence sensor event related to the at least one first dynamic sensor to be added to the sensors to be monitored, and the method further comprises:
detecting the first entity presence sensor event;
creating the SDR and the sensor information of the at least one first dynamic sensor according to the first entity presence sensor event;
updating the dynamic sensor information table to add the sensor information of the at least one first dynamic sensor thereto; and
updating the dynamic SDR table to add the SDR of the at least one first dynamic sensor thereto.

15. The method of claim 13, wherein the entity presence sensor event is a second entity presence sensor event related to the at least one second dynamic sensor to be removed from the sensors to be monitored, and the method further comprises:
detecting the second entity presence sensor event;
removing the SDR and the sensor information of the at least one second dynamic sensor according to the second entity presence sensor event;
updating the dynamic sensor information table to remove the sensor information of the at least one second dynamic sensor therefrom; and
updating the dynamic sensor remove table to add the sensor number of the at least one second dynamic sensor thereto.

16. The method of claim 9, further comprising:
in response to updating the SDR and the sensor information of the at least one dynamic sensor, posting an event message in a system event log (SEL).

17. A non-transitory computer readable medium storing computer executable code, wherein the computer executable code, when executed at a processor of a baseboard management controller (BMC), is configured to:
initiate, in a memory of the BMC, a plurality of dynamic sensor tables;
in a sensor monitor cycle:
monitor a plurality of sensors to be monitored, in order to get sensor reading information from each of the sensors;
determine whether an entity presence sensor event is detected, wherein the entity presence sensor event is related to at least one dynamic sensor to be added to or removed from the sensors to be monitored; and
in response to detecting the entity presence sensor event, update a sensor data repository (SDR) and sensor information of the at least one dynamic sensor according to the entity presence sensor event, and update the dynamic sensor tables;
in response to determining that the sensor monitor cycle is completed, determine whether the dynamic sensor tables are updated; and
in response to determining the dynamic sensor tables are updated, update the SDR and the sensor information of the at least one dynamic sensor to the IPMI stack based on the updated dynamic sensor tables.

18. The non-transitory computer readable medium of claim 17, wherein the dynamic sensor tables comprise:
a dynamic sensor information table, configured to store the sensor information of the sensors to be monitored;
a dynamic SDR table, configured to store the SDR of at least one first dynamic sensor to be added to the sensors to be monitored; and
a dynamic sensor remove table, configured to store a sensor number of at least one second dynamic sensor to be removed from the sensors to be monitored.

19. The non-transitory computer readable medium of claim 18, wherein the entity presence sensor event is a first entity presence sensor event related to the at least one first dynamic sensor to be added to the sensors to be monitored, and the computer executable code is configured to, when executed at the processor:
detect the first entity presence sensor event;
create the SDR and the sensor information of the at least one first dynamic sensor according to the first entity presence sensor event;
update the dynamic sensor information table to add the sensor information of the at least one first dynamic sensor thereto; and
update the dynamic SDR table to add the SDR of the at least one first dynamic sensor thereto.

20. The non-transitory computer readable medium of claim 18, wherein the entity presence sensor event is a second entity presence sensor event related to the at least one second dynamic sensor to be removed from the sensors to be monitored, and the computer executable code is configured to, when executed at the processor:
detect the second entity presence sensor event;
remove the SDR and the sensor information of the at least one second dynamic sensor according to the second entity presence sensor event;
update the dynamic sensor information table to remove the sensor information of the at least one second dynamic sensor therefrom; and
update the dynamic sensor remove table to add the sensor number of the at least one second dynamic sensor thereto.
